(19) United States
(12) Patent Application Publication
(10) Pub. No.: US 2017/0024998 A1
(43) Pub. Date: Jan. 26, 2017

(54) SETTING METHOD AND APPARATUS FOR SURVEILLANCE SYSTEM, AND COMPUTER-READABLE RECORDING MEDIUM

(71) Applicant: VIVOTEK INC., New Taipei City (TW)

(72) Inventor: CHENG-CHIEH LIU, New Taipei City (TW)

(21) Appl. No.: 15/217,498

(22) Filed: Jul. 22, 2016

(30) Foreign Application Priority Data
Jul. 24, 2015 (TW) 104124182

(51) Int. Cl. G08B 29/22; G08B 29/18; H04N 7/18

(52) U.S. Cl. CPC G08B 29/22; H04N 7/181; G08B 29/185

(57) ABSTRACT

A setting method for a surveillance system includes: receiving a set value that indicates the frequency at which a notification is sent; selecting one or more historical physical quantities from a historical monitoring record according to the set value; calculating a given threshold according to the historical physical quantity; and setting the given threshold as a judgment threshold for determining whether to send the notification.

### CROSS-REFERENCES TO RELATED APPLICATIONS

This non-provisional application claims priority under 35 U.S.C. §119(a) on Patent Application No. 104124182 filed in Taiwan, R.O.C. on 2015 Jul. 24, the entire contents of which are hereby incorporated by reference.

### BACKGROUND

Technical Field

The present invention relates to a video surveillance system, and more particularly to a setting method and apparatus for a surveillance system, and a computer-readable recording medium.

Related Art

In recent years, video surveillance systems have gained much popularity and have been widely used for security related purposes. For example, video surveillance systems are installed in airports, subway stations, banks, hotels or the like to continuously capture images of the scene for real-time monitoring or as records for evidence.

Many video surveillance systems have adopted image analysis technologies to perform automatic video surveillance processes. In an automatic video surveillance process, after an image of the scene is captured, the video surveillance system can analyze the captured image of the scene to identify an object of interest to the user or a suspicious object. After analyzing the image, the video surveillance system determines, on the basis of the recognized object, whether an abnormal event occurs. When an abnormal event occurs, the video surveillance system can send an alarm message to the user by initiating a voice call through a network, sending an SMS message, or sending an email.

Generally, when the video surveillance system performs automatic security monitoring processes such as motion detection, abnormal pattern detection, or common video content analysis (VCA), some thresholds need to be set as a basis of judgment. When a preset threshold condition is satisfied, the video surveillance system sends the alarm message. However, if the threshold is excessively low, lots of events may be triggered, and the alarm message may be sent all the time, disturbing the user. If the threshold is excessively high, almost no event can be detected, and the opportunity for taking measures in time may be lost. Therefore, there is a need for improvement.

### SUMMARY

In one embodiment, a setting method for a surveillance system includes: receiving a set value that indicates the frequency at which a notification is sent; selecting at least one historical physical quantity from a historical monitoring record according to the set value; calculating a given threshold according to the historical physical quantity; and setting the given threshold as a judgment threshold for determining whether to send the notification.

In another embodiment, a setting method for a surveillance system includes: receiving a set value that indicates the frequency at which a notification is sent; selecting, according to the set value and a given time period, at least one historical physical quantity from a historical monitoring record that is accumulated in the given time period; calculating a given threshold according to the historical physical quantity; and setting the given threshold as a judgment threshold for determining whether to send the notification.

On the basis of the above, according to the setting method for a surveillance system of the present invention, a suitable judgment threshold is generated automatically according to the frequency at which the notification is sent and the historical monitoring record, which provides a simple and intuitive method for setting the judgment threshold and makes the actual frequency at which the notification is sent approaches that expected by the user. In other words, as long as the user determines the frequency at which an event occurs (for example, the event occurs several times per day), a threshold satisfying the number of times that is set by the user can be automatically generated by means of the setting method for a surveillance system according to any embodiment, thereby precisely setting the threshold and effectively resolving the problem that the user is disturbed by the frequent sending of alarm messages that is caused by occurrence of events that are not of interest to the user.

### BRIEF DESCRIPTION OF THE DRAWINGS

The present invention will become more fully understood from the detailed description given herein below for illustration only, and thus are not limitative of the present invention, and wherein:

FIG. 1 is a schematic flowchart of a setting method for a surveillance system according to a first embodiment of the present invention;

FIG. 2 is a schematic diagram of an embodiment of an electronic apparatus for implementing the setting method for a surveillance system of FIG. 1;

FIG. 3 shows a setting method for a surveillance system of an embodiment of step S130 of FIG. 1;

FIG. 4 shows a setting method for a surveillance system of another embodiment of step S130 of FIG. 1;

FIG. 5 is a schematic flowchart of a setting method for a surveillance system according to a second embodiment of the present invention;

FIG. 6 shows a setting method for a surveillance system of an embodiment of step S130′ of FIG. 5;

FIG. 7 is a schematic diagram of an embodiment of a historical monitoring record;

FIG. 8 is a schematic flowchart of a setting method for a surveillance system according to a third embodiment of the present invention; and

FIG. 9 is a schematic flowchart of a setting method for a surveillance system according to a fourth embodiment of the present invention.

### DETAILED DESCRIPTION

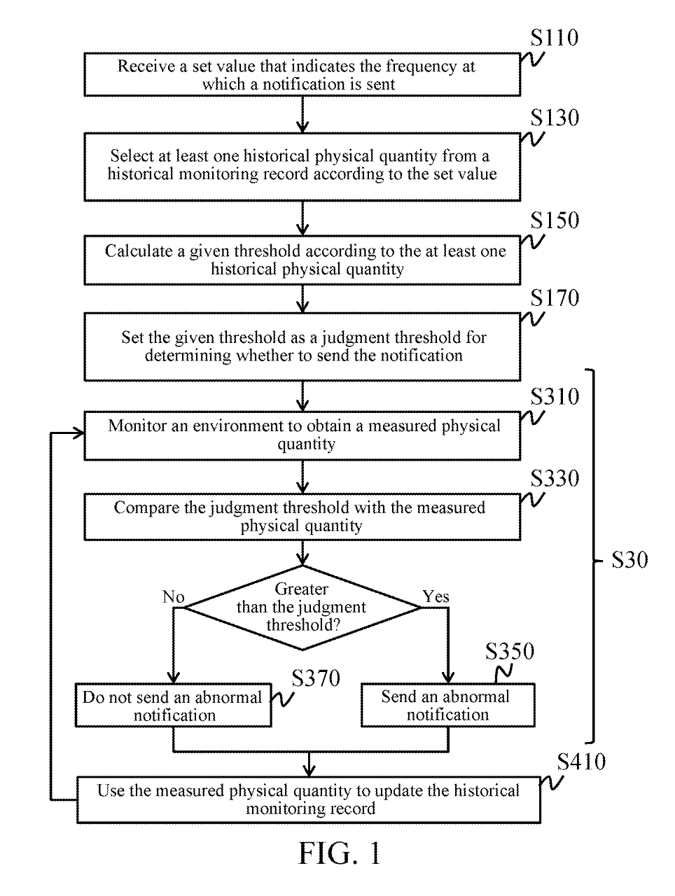

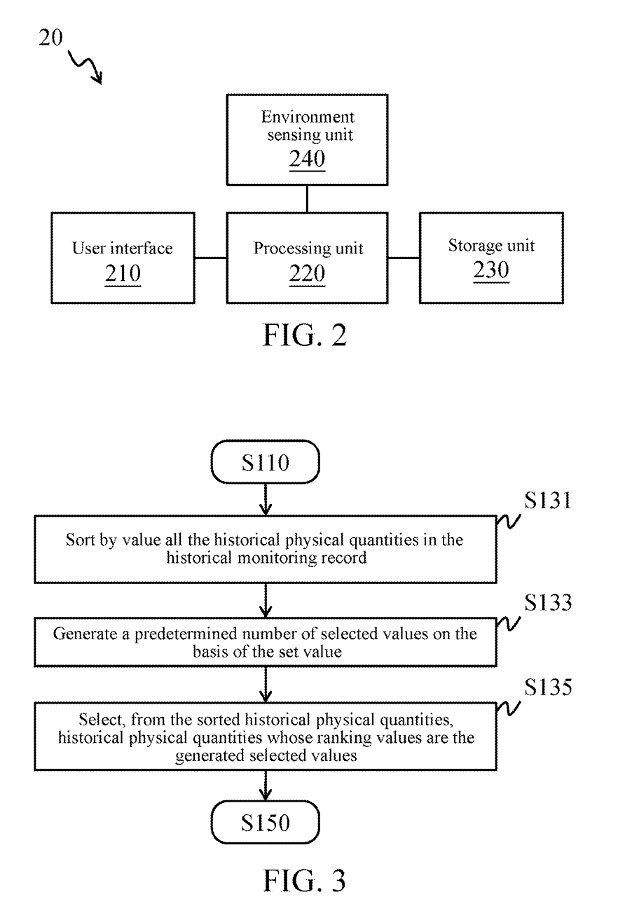

FIG. 1 is a schematic flowchart of a setting method for a surveillance system according to a first embodiment of the present invention. FIG. 2 is a schematic diagram of an embodiment of an electronic apparatus for implementing the setting method for a surveillance system of FIG. 1.

Referring to FIG. 1 and FIG. 2, the setting method for a surveillance system according to the present invention may be implemented by a computer program, so that after a computer (which is any electronic apparatus 20 having a user interface 210, a processing unit 220, and a storage unit 230, that is, a surveillance system) loads and runs the program, a setting method for a surveillance system of any embodiment can be implemented. In some embodiments, the user interface 210 may be a touchscreen, a combination of an ordinary display screen and a plurality of physical keys, or a combination of a touchscreen and one or more physical keys. The physical keys may be realized by a keyboard, a mouse, or a combination thereof.

The storage unit 230 stores a historical monitoring record consisting of a plurality of historical physical quantities. Herein, the historical physical quantities are measured physical quantities that are obtained by the processing unit 220 when previously performing a security monitoring process.

In some embodiments, the security monitoring process may be motion detection, abnormal pattern detection, video content analysis (VCA), audio content analysis, or a combination thereof. In some embodiments, the measured physical quantity is a monitoring result obtained by the electronic apparatus 20 after continuously monitoring an environment for a given time period. For example, the measured physical quantity may be a sensing result outputted by at least one environment sensing unit 240 that is used for sensing the status of the environment, or an analytical result generated by the processing unit 220 after analyzing the sensing result of the environment sensing unit 240 about the status of the environment. In some embodiments, the given time period may be a given number of days. In some embodiments, the given number of days may be any user-specified time period, for example (but not limited to), 1 hour, 3 hours, 1 day, 3 days, or 1 week.

In some embodiments, the environment sensing unit 240 may be a camera, a microphone, an acceleration sensor, an infrared sensor, a temperature sensor, a pressure sensor, a photo-interrupter, or the like. In some embodiments, the measured physical quantity may be a sound volume, the number of target objects, the number of times of movement of a target object, the speed of movement of a target object, the range of movement of a target object (for example, the distance of movement, or the proportion of the area of movement), the change of pixels in two consecutive images (the percentage to the image), duration, temperature, pressure, acceleration, the number of events, or the like.

In one embodiment, a user may operate the user interface 210 according to the frequency at which he/she wants to receive an alarm message (the frequency at which a notification is sent) to enter a set value that indicates the frequency at which a notification is sent. The processing unit 220 receives the set value from the user interface 210 (step S110), and selects one or more historical physical quantities from the historical monitoring record according to the received set value (step S130). Then, the processing unit 220 calculates a given threshold according to the selected historical physical quantity (step S150), and sets the calculated given threshold as a judgment threshold for determining whether to send the notification (step S170). In some embodiments, the set value represents the number of times a notification is sent per day (for example, twice per day).

In some embodiments of step S130, referring to FIG. 3, the processing unit 220 sorts by value all the historical physical quantities in the historical monitoring record (S131), generates a predetermined number of selected values on the basis of the set value (S133), and then selects, from the sorted historical physical quantities, historical physical quantities whose ranking values are the generated selected values (S135). Herein, the predetermined number and the selected value are positive integers.

In some embodiments, when an extremum in all the historical physical quantities is a maximum, in step S131, the processing unit 220 sorts all the historical physical quantities in the historical monitoring record in descending order (sorting in descending powers).

In some other embodiments, when an extremum in all the historical physical quantities is a minimum, in step S131, the processing unit 220 sorts all the historical physical quantities in the historical monitoring record in ascending order (sorting in ascending powers).

In some embodiments, when the predetermined number is 1, the processing unit 220 may directly use the set value as a selected value. Herein, the set value is limited to a positive integer.

In some embodiments, when the predetermined number is 1, the processing unit 220 may use a positive integer that is closest to or equal to the set value as a selected value. In this case, the set value may not be limited to a positive integer. However, in some embodiments, the set value may still be limited to a positive number.

In some embodiments, when the predetermined number is more than one, the processing unit 220 may use a predetermined number of positive integers that are closest to or equal to the set value as selected values. In this case, the set value may not be limited to a positive integer. However, in some embodiments, the set value may still be limited to a positive number.

For example, if the predetermined number is 2, the processing unit 220 may use a positive integer that is closest to and greater than or equal to the set value as one selected value, and use a positive integer that is closest to and smaller than the set value as the other selected value.

In some embodiments of step S150, if the number of selected historical physical quantities is 1 (hereinafter referred to as a first physical quantity), the processing unit 220 may generate the given threshold according to the first physical quantity and a preset value. The preset value is a fixed value, for example, a minimum scale of the measured physical quantity or a multiple thereof.

In some embodiments, when the ranking value of the first physical quantity in the historical physical quantity after sorting in descending powers is closest to and is greater than or equal to the set value, the processing unit 220 generates the given threshold by subtracting the preset value from the first physical quantity.

In some embodiments, when the ranking value of the first physical quantity in the historical physical quantity after sorting in descending powers is closest to and smaller than the set value, the processing unit 220 generates the given threshold by adding up the first physical quantity and the preset value.

In some embodiments, when the ranking value of the first physical quantity in the historical physical quantity after sorting in ascending powers is closest to and is greater than or equal to the set value, the processing unit 220 generates the given threshold by adding up the first physical quantity and the preset value.

In some embodiments, when the ranking value of the first physical quantity in the historical physical quantity after sorting in ascending powers is closest to and smaller than the set value, the processing unit 220 generates the given threshold by subtracting the preset value from the first physical quantity.

In some other embodiments of step S150, if the number of selected historical physical quantities is 1 (hereinafter referred to as a first physical quantity), the processing unit 220 may directly use the first physical quantity as the given threshold.

In still some other embodiments of step S150, if the number of selected historical physical quantities is more than one, the processing unit 220 may perform a mathematical operation for the selected historical physical quantities to obtain the given threshold. The mathematical operation may be an operation of calculating an arithmetic mean of the historical physical quantities, an operation of calculating a weighted mean of the historical physical quantities, or an operation of calculating a median of the historical physical quantities.

Assume that the number of selected historical physical quantities is two (hereinafter referred to as a first physical quantity and a second physical quantity), the ranking value of the first physical quantity in the historical physical quantity after sorting is closest to and is greater than or equal to the set value, and the ranking value of the second physical quantity in the historical physical quantity after sorting in descending powers is closest to and smaller than the set value. The processing unit 220 performs a mathematical operation for the first physical quantity and the second physical quantity to obtain a given threshold that is between the first physical quantity and the second physical quantity.

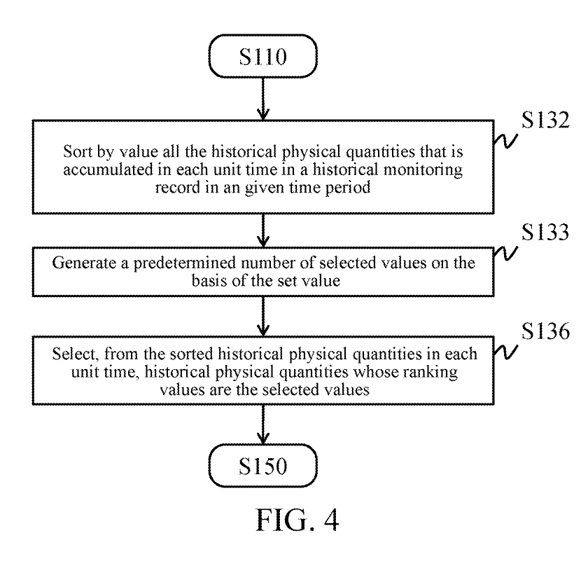

In some other embodiments of step S130, referring to FIG. 4, the processing unit 220 sorts by value all the historical physical quantities that is accumulated in each unit time in a historical monitoring record in an given time period (S132), generates a predetermined number of selected values on the basis of the set value (S133), and then selects, from the sorted historical physical quantities in each unit time, historical physical quantities whose ranking values are the selected values, that is, selects a plurality of historical physical quantities (S136). Herein, the number of selected historical physical quantities=the predetermined number×the given time period/unit time. The predetermined number and the selected value are positive integers. In one embodiment, the given time period is a given number of days, and the unit time is one day.

Next, the processing unit 220 separately performs a mathematical operation for historical physical quantities that have the same ranking value in the selected historical physical quantities to generate their respective mathematical operation values. The mathematical operation may be an operation of calculating an arithmetic mean of these historical physical quantities, an operation of calculating a weighted mean of these historical physical quantities, or an operation of calculating a median of these historical physical quantities.

In some embodiments of step S150, if the predetermined number is 1, the selected historical physical quantities is hereinafter referred to as plurality of first physical quantities, and the processing unit 220 generates a mathematical operation value of these first physical quantities. Next, the processing unit 220 may generate the given threshold according to the mathematical operation value of the first physical quantities and a preset value. The preset value is a fixed value, for example, a minimum scale of the measured physical quantity or a multiple thereof.

In some embodiments, when the ranking value of the first physical quantity in the historical physical quantity after sorting in descending powers is closest to and is greater than or equal to the set value, the processing unit 220 generates the given threshold by subtracting the preset value from the mathematical operation value of the first physical quantities.

In some embodiments, when the ranking value of the first physical quantity in the historical physical quantity after sorting in descending powers is closest to and smaller than the set value, the processing unit 220 generates the given threshold by adding up the mathematical operation value of the first physical quantities and the preset value.

In some embodiments, when the ranking value of the first physical quantity in the historical physical quantity after sorting in ascending powers is closest to and is greater than or equal to the set value, the processing unit 220 generates the given threshold by adding up the mathematical operation value of the first physical quantities and the preset value.

In some embodiments, when the ranking value of the first physical quantity in the historical physical quantity after sorting in ascending powers is closest to and smaller than the set value, the processing unit 220 generates the given threshold by subtracting the preset value from the mathematical operation value of the first physical quantities.

In some other embodiments of step S150, if the predetermined number is 1, the selected historical physical quantities is hereinafter referred to as a plurality of first physical quantities, and the processing unit 220 generates a mathematical operation value of these first physical quantities. In this case, the processing unit 220 may directly use the mathematical operation value of the first physical quantities as the given threshold.

In still some other embodiments of step S150, if the predetermined number is 2, a plurality of historical physical quantities corresponding to a first selected value is hereinafter referred to as a plurality of first physical quantities, and a plurality of historical physical quantities corresponding to a second selected value is hereinafter referred to as a plurality of second physical quantities. The processing unit 220 generates a mathematical operation value of these first physical quantities and a mathematical operation value of these second physical quantities. Next, the processing unit 220 may perform a mathematical operation for the mathematical operation value of these first physical quantities and the mathematical operation value of these second physical quantities to obtain the given threshold. The mathematical operation may be an operation of calculating an arithmetic mean of the historical physical quantities, an operation of calculating a weighted mean of the historical physical quantities, or an operation of calculating a median of the historical physical quantities.

For example, assume that the given time period is 2 days (hereinafter referred to as a first day and a second day) and the selected value is 1. The processing unit 220 sorts by value all historical physical quantities that are accumulated/recorded in the first day to obtain a first group of sorted historical physical quantities, and sorts by value all historical physical quantities that are accumulated/recorded in the second day to obtain a second group of sorted historical physical quantities. Then, the processing unit 220 selects, from the first group of sorted historical physical quantities, a historical physical quantity whose ranking value is 1 (that is, a first physical quantity), and selects, from the second group of sorted historical physical quantities, a historical physical quantity whose ranking value is 1 (that is, another first physical quantity), thus obtaining two first physical quantities. Next, the processing unit 220 performs a mathematical operation for the two selected first physical quantities to generate a mathematical operation value of the first physical quantities. Then, the processing unit 220 calculates a given threshold according to the mathematical operation value of the first physical quantities.

For another example, assume that the given time period is 2 days (hereinafter referred to as a first day and a second day) and the selected values are 1 and 2. The processing unit 220 sorts by value all historical physical quantities that are accumulated/recorded in the first day to obtain a first group of sorted historical physical quantities, and sorts by value all historical physical quantities that are accumulated/recorded in the second day to obtain a second group of sorted historical physical quantities. Then, the processing unit 220 selects, from the first group of sorted historical physical quantities, historical physical quantities whose ranking values are 1 and 2 (that is, a first physical quantity and a second physical quantity), and selects, from the second group of sorted historical physical quantities, historical physical quantities whose ranking values are 1 and 2 (that is, another first physical quantity and another second physical quantity), thus obtaining two first physical quantities and two second physical quantities. Next, the processing unit 220 performs a mathematical operation for the two selected first physical quantities to generate a mathematical operation value of the first physical quantities and performs a mathematical operation for the two selected second physical quantities to generate a mathematical operation value of the second physical quantities. Then, the processing unit 220 calculates a given threshold according to the mathematical operation value of the first physical quantities and the mathematical operation value of the second physical quantities.

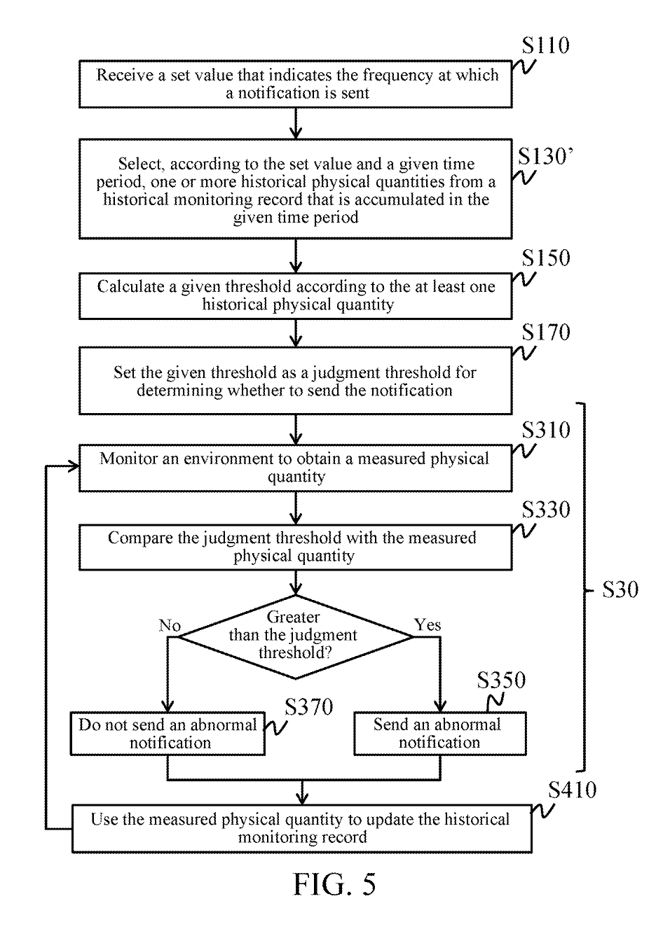

In another embodiment, referring to FIG. 5, the processing unit 220 may select, according to the set value and a given time period, one or more historical physical quantities from a historical monitoring record that is accumulated in the given time period (step S130′).

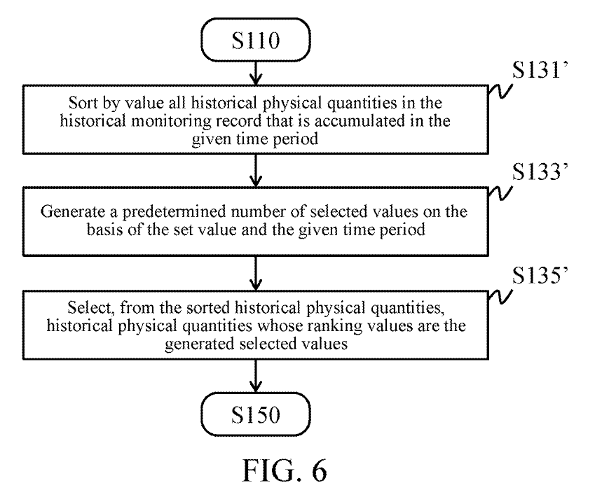

In some embodiments of step S130′, referring to FIG. 6, the processing unit 220 sorts by value all historical physical quantities in the historical monitoring record that is accumulated in the given time period (S131′), generates a predetermined number of selected values on the basis of the set value and the given time period (S133′), and then selects, from the sorted historical physical quantities, historical physical quantities whose ranking values are the generated selected values (S135′). Herein, the predetermined number and the selected value are positive integers.

In some embodiments, when an extremum in all the historical physical quantities is a maximum, in step S131′, the processing unit 220 sorts all the historical physical quantities in the historical monitoring record that is accumulated in the given time period in descending order (sorting in descending powers).

In some other embodiments, when an extremum in all the historical physical quantities is a minimum, in step S131′, the processing unit 220 sorts all the historical physical quantities in the historical monitoring record that is accumulated in the given time period in ascending order (sorting in ascending powers).

In some embodiments of step S135′, the processing unit 220 first calculates the product of the set value and the value of the given time period (hereinafter referred to as a first value).

In some embodiments, when the predetermined number is 1, the processing unit 220 may directly use the first value as a selected value. Herein, the first value is limited to a positive integer. For example, assuming that the set value is 2 and the given time period is 3 days (that is, the value of the given time period is 3), the first value and the selected value are 6.

In some embodiments, when the predetermined number is 1, the processing unit 220 may use a positive integer that is closest to or equal to the first value as a selected value. In this case, the set value may not be limited to a positive integer. However, in some embodiments, the set value may still be limited to a positive number. For example, assuming that the set value is 1.5 and the given time period is 3 days (that is, the value of the given time period is 3), the first value is 4.5 and the selected value may be 4 or 5.

In some embodiments, when the predetermined number is more than one, the processing unit 220 may use a predetermined number of positive integers that are closest to or equal to the set value as selected values. In this case, the set value may not be limited to a positive integer. However, in some embodiments, the set value may still be limited to a positive number. For example, assuming that the set value is 1.5, the given time period is 3 days (that is, the value of the given time period is 3) and the predetermined number is 3, the first value is 4.5 and the selected values may be {2, 3, 4}, {3, 4, 5}, {4, 5, 6}, or {5, 6, 7}. Preferably, the first value is between a maximum and a minimum of the selected values.

In some embodiments, preferably, the predetermined number is 2, and the processing unit 220 uses a positive integer that is closest to and is greater than or equal to the first value as one selected value, and uses a positive integer that is closest to and smaller than the first value as the other selected value.

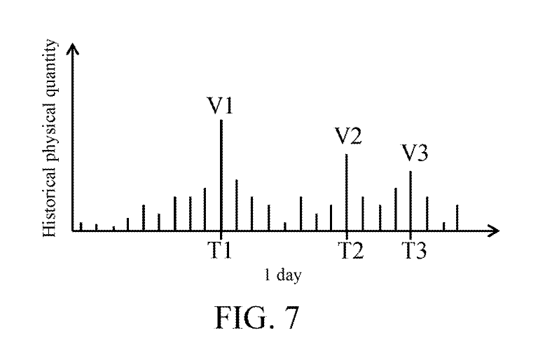

For example, referring to FIG. 7, the horizontal axis represents the given time period (which is, for example, 1 day), and the vertical axis represents the historical physical quantity (which is, for example, the size of the area of movement obtained by motion detection (that is, amount of movement)). That is to say, in a historical monitoring record of 1 day, amounts of movement V1, V2 and V3 respectively at time points T1, T2, T3 are the largest three.

If the set value entered by the user is 1 (that is, the notification is sent once per day), the processing unit 220 automatically estimates, according to the amount of movement V1 and the amount of movement V2, a given threshold that is therebetween, and sets the given threshold as the judgment threshold.

If the set value entered by the user is 2 (that is, the notification is sent twice per day), the processing unit 220 automatically estimates, according to the amount of movement V2 and the amount of movement V3, a given threshold that is therebetween, and sets the given threshold as the judgment threshold.

In some embodiments, after the judgment threshold is set (step S170), the processing unit 220 may continue to perform the security monitoring process on the basis of the judgment threshold (step S30).

Referring to FIG. 1 and FIG. 5, the processing unit 220 monitors an environment to obtain a measured physical quantity (step S310), and compares the judgment threshold with the measured physical quantity (step S330). When the measured physical quantity is greater than the judgment threshold, the processing unit 220 sends an abnormal notification to the user (step S350). When the measured physical quantity is not greater than the judgment threshold, the processing unit 220 does not send an abnormal notification (step S370).

Herein, the processing unit 220 repeatedly performs the security monitoring process (step S30) to obtain a plurality of measured physical quantities, and uses the obtained plurality of measured physical quantities to update the historical monitoring record (step S410).

In some embodiments, the processing unit 220 may send an abnormal notification by initiating a voice call through a network, sending an SMS message, or sending an email, so as to notify the user that an abnormal event occurs.

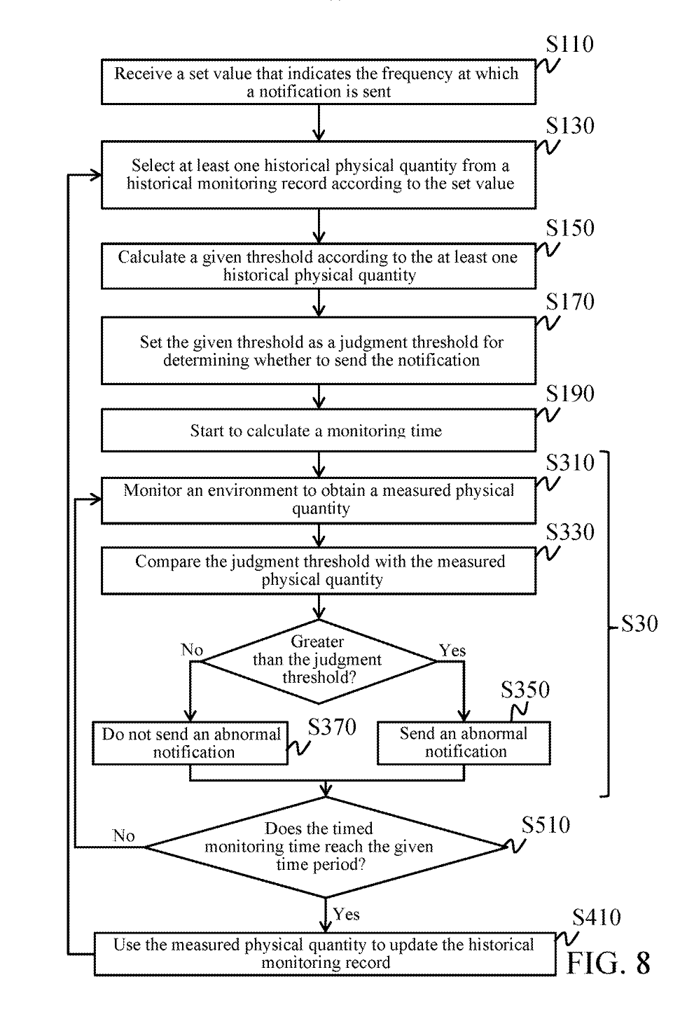

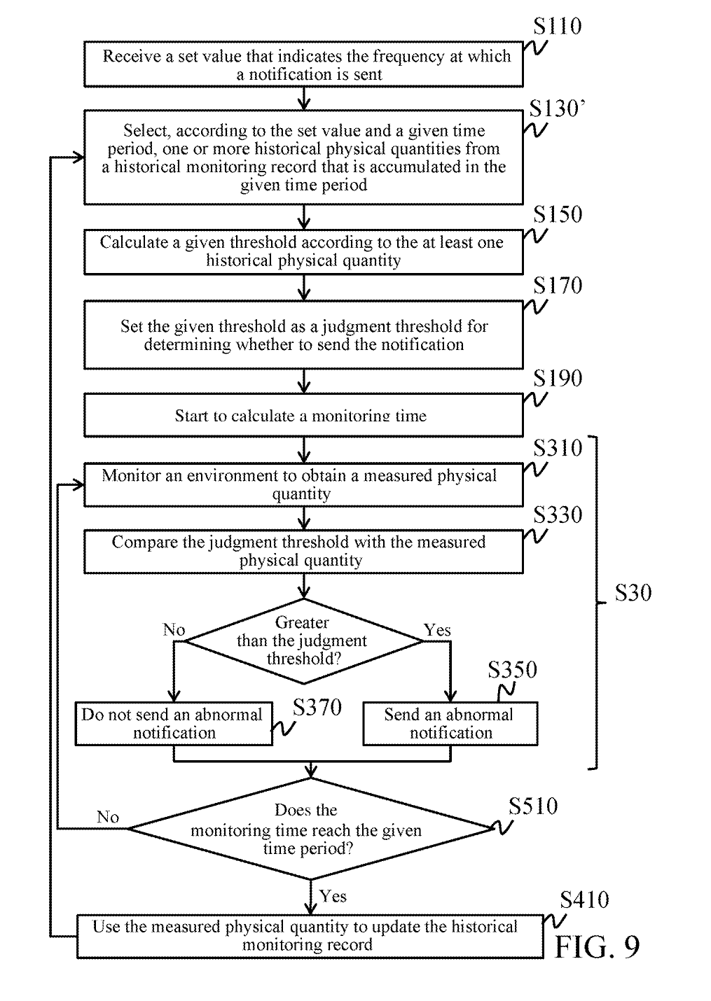

In some embodiments, referring to FIG. 8 and FIG. 9, each time the processing unit 220 starts monitoring, the processing unit 220 calculates a monitoring time (step S190). During the monitoring process, the processing unit 220 determines whether the calculated monitoring time reaches the given time period (step S510). Before the monitoring time reaches the given time period, the processing unit 220 repeatedly performs the security monitoring process (step S30) to obtain a plurality of measured physical quantities, and uses the obtained plurality of measured physical quantities to update the historical monitoring record (step S410). When the monitoring time reaches the given time period, the processing unit 220 executes step S130 (or step S130′), to recalculate the given threshold (or step S150) and uses the recalculated given threshold to update the settings (or step S170).

That is to say, the electronic apparatus 20 not only can trigger the process of setting the judgment threshold when the user enters the set value (step S110 to step S170), but also can trigger the process of setting the judgment threshold at intervals of the given time period (step S110 to step S170).

In some embodiments, the process of setting the judgment threshold (step S110 to step S170) of these embodiments may also be used for post search of abnormal events. In other words, after step S170, the processing unit 220 compares the judgment threshold with each historical physical quantity in the historical monitoring record, to find historical physical quantities that are greater than the judgment threshold. After completing the comparison, the processing unit 220 provides information about the historical physical quantities that are greater than the judgment threshold (for example, the value of the historical physical quantity and the monitoring time point represented by it) to the user. For example, the processing unit 220 outputs a report and displays the report on a screen (the user interface 210).

In some embodiments, the processing unit 220 may be realized by one or more microprocessors, microcontrollers, digital signal processors, microcomputers, central processing units, field programmable gate arrays, programmable logic devices, state machines, logic circuits, analog circuits, digital circuits, and/or any processing element based on operating instructions/operating signals (analog and/or digital).

In some embodiments, the storage unit 230 may be realized by one or more memories.

On the basis of the above, according to the setting method for a surveillance system of the present invention, a suitable judgment threshold is generated automatically according to the frequency at which the notification is sent and the historical monitoring record, which provides a simple and intuitive method for setting the judgment threshold and makes the actual frequency at which the notification is sent approaches that expected by the user. In other words, as long as the user determines the frequency at which an event occurs (for example, the event occurs several times per day), a threshold satisfying the number of times that is set by the user can be automatically generated by means of the setting method for a surveillance system according to any embodiment, thereby precisely setting the threshold and effectively resolving the problem that the user is disturbed by the frequent sending of notifications that is caused by occurrence of events that are not of interest to the user.

What is claimed is:

1. A setting method for a surveillance system, comprising:
receiving a set value that indicates the frequency at which a notification is sent;
selecting at least one historical physical quantity from a historical monitoring record according to the set value;
calculating a given threshold according to the at least one historical physical quantity; and
setting the given threshold as a judgment threshold for determining whether to send the notification.

2. The setting method for a surveillance system according to claim 1, wherein the at least one historical physical quantity comprises a first physical quantity and a second physical quantity, a ranking value of the first physical quantity in the historical monitoring record after sorting by value is closest to and greater than the set value or is equal to the set value, and a ranking value of the second physical quantity in the historical monitoring record after sorting by value is closest to and smaller than the set value.

3. The setting method for a surveillance system according to claim 2, wherein the given threshold is between the first physical quantity and the second physical quantity.

4. The setting method for a surveillance system according to claim 1, wherein the set value is an integer, the at least one historical physical quantity comprises a first physical quantity, and a ranking value of the first physical quantity in the historical monitoring record after sorting by value is equal to the set value.

5. The setting method for a surveillance system according to claim 4, wherein the given threshold is equal to the first physical quantity or is smaller than the first physical quantity by a preset value.

6. The setting method for a surveillance system according to claim 1, wherein the at least one historical physical quantity comprises a plurality of first physical quantities and a plurality of second physical quantities, a ranking value of each of the first physical quantities in the historical monitoring record that is accumulated in each unit time in a given time period after sorting by value is closest to and greater than the set value or is equal to the set value, and a ranking value of each of the second physical quantities in the historical monitoring record that is accumulated in each the unit time after sorting by value is closest to and smaller than the set value.

7. The setting method for a surveillance system according to claim 6, wherein the given threshold is between a mathematical operation value of the first physical quantities and a mathematical operation value of the second physical quantities.

8. The setting method for a surveillance system according to claim 1, wherein the set value is an integer, the at least one historical physical quantity comprises a plurality of first physical quantities, and a ranking value of each of the first physical quantities in the historical monitoring record that is accumulated in each unit time in a given time period after sorting by value is equal to the set value.

9. The setting method for a surveillance system according to claim 8, wherein the given threshold is equal to a mathematical operation value of the first physical quantities or is smaller than the mathematical operation value of the first physical quantities by a preset value.

10. The setting method for a surveillance system according to claim 1, further comprising:
continuously monitoring an environment for a given time period, to obtain a plurality of measured physical quantities;
when each of the measured physical quantities is generated, comparing the judgment threshold with the measured physical quantity;
sending an abnormal notification when the measured physical quantity is greater than the judgment threshold;
using the measured physical quantities to update the historical monitoring record; and
re-executing, on the basis of the updated historical monitoring record, the step of selecting the at least one historical physical quantity, the step of calculating the given threshold, and the step of setting the judgment threshold.

11. The setting method for a surveillance system according to claim 10, wherein the given time period is a given number of days.

12. The setting method for a surveillance system according to claim 1, wherein the set value represents the number of times the notification is sent per day.

13. The setting method for a surveillance system according to claim 1, wherein the step of selecting the at least one historical physical quantity from a historical monitoring record according to the set value comprises:
selecting, according to the set value and a given time period, the at least one historical physical quantity from the historical monitoring record that is accumulated in the given time period.

14. The setting method for a surveillance system according to claim 13, wherein the at least one historical physical quantity comprises a first physical quantity and a second physical quantity, a ranking value of the first physical quantity in the historical monitoring record after sorting by value is closest to and greater than the product of the set value and the value of the given time period or is equal to the product of the set value and the value of the given time period, and a ranking value of the second physical quantity in the historical monitoring record after sorting by value is closest to and smaller than the product of the set value and the value of the given time period.

15. The setting method for a surveillance system according to claim 13, wherein the product of the set value and the value of the given time period is an integer, the at least one historical physical quantity comprises a first physical quantity, and a ranking value of the first physical quantity in the historical monitoring record after sorting by value is equal to the product of the set value and the value of the given time period.

16. A computer-readable recording medium, comprising a computer program, wherein a computer runs the computer program to perform the setting method for a surveillance system according to claim 1.

17. A setting apparatus for a surveillance system, comprising:
a user interface, configured to receive a set value that indicates the frequency at which a notification is sent
a storage unit, configured to store a historical monitoring record, wherein the historical monitoring record; and
a processing unit, coupled to the user interface and the storage unit, and configured to perform following actions:
selecting at least one historical physical quantity from the historical monitoring record according to the set value;
calculating a given threshold according to the at least one historical physical quantity; and
setting the given threshold as a judgment threshold for determining whether to send the notification.

18. The setting apparatus for a surveillance system according to claim 17, wherein the at least one historical physical quantity comprises a first physical quantity and a second physical quantity, a ranking value of the first physical quantity in the historical monitoring record after sorting by value is closest to and greater than the set value or is equal to the set value, and a ranking value of the second physical quantity in the historical monitoring record after sorting by value is closest to and smaller than the set value.

19. The setting apparatus for a surveillance system according to claim 17, wherein the processing unit is further configured to perform following actions:
continuously monitoring an environment for a given time period, to obtain a plurality of measured physical quantities;
when each of the measured physical quantities is generated, comparing the judgment threshold with the measured physical quantity;
sending an abnormal notification when the measured physical quantity is greater than the judgment threshold;
updating the historical monitoring record with the measured physical quantities; and
re-performing, on the basis of the updated historical monitoring record, the action of selecting the at least one historical physical quantity, the action of calculating the given threshold, and the action of setting the judgment threshold.

20. The setting apparatus for a surveillance system according to claim 17, wherein the processing unit selects the at least one historical physical quantity from the historical monitoring record accumulated in a given time period according to the set value.
